(19) United States
(12) Patent Application Publication
(10) Pub. No.: US 2024/0113351 A1
(43) Pub. Date: Apr. 4, 2024

(54) COOLING OF A BATTERY PACK IN A SYSTEM COMPRISING A TOOL, A BATTERY PACK AND A CHARGER

(71) Applicant: HUSQVARNA AB, Huskvarna (SE)

(72) Inventors: Glenn Torsténi, Jonsered (SE); Anders Gidoff, Vaggeryd (SE)

(21) Appl. No.: 18/276,348

(22) PCT Filed: Feb. 2, 2022
(86) PCT No.: PCT/SE2022/050114

§ 371 Date: Aug. 8, 2023

(30) Foreign Application Priority Data
Feb. 9, 2021 (SE) 2150140-8

(51) Int. Cl. H01M 10/613; H01M 10/6235

(52) U.S. Cl. CPC H01M 10/613; H01M 10/6235; H01M 2200/10

(57) ABSTRACT

The present disclosure relates to a battery-operated system comprising a tool (1), a battery pack (3) configured to power the tool by being inserted in a tool socket (5) of the tool, and a charger (7), comprising a charger socket (9) for charging the cooling channel (13) extending from a first (15) to a second (17) opening in the housing. The tool (1) comprises a fan arrangement (19) for cooling the battery pack (3) during use by forcing air from battery pack (3). The battery pack (3) has a housing (11) and a the first (15) to the second (17) opening in the battery pack housing (11), and the charger (7) comprising a fan arrangement (21) for cooling the battery pack (3) during charging but instead forcing air housing (11). This means that a battery cell that may become the hottest during discharging is cooled at ambient temperature during charging meaning that full charging can be attained faster.

### TECHNICAL FIELD

The present disclosure relates to a battery-operated system comprising a tool, a battery pack configured to power said tool by being inserted in a tool socket of the tool, and a charger, comprising a charger socket for charging said battery pack.

### BACKGROUND

Such battery-operated systems are widely used as an alternative to tools with combustion engines and tools connected to power outlets by means of a cord. Thereby, flexible, cordless use is provided without exhaust emissions. Several battery packs can be used to allow more or less continuous use of the tool, for instance. A battery pack can also be used in several different tools.

One problem associated with battery-operated systems of this kind is how to obtain efficient charging of discharged battery packs to, for instance, reduce the waiting time until the battery pack is fully charged or at least useable again.

### SUMMARY

One object of the present disclosure is therefore to obtain more efficient charging of a battery pack in a battery-operated system. This object is achieved, in a system of the initially mentioned kind wherein the battery pack comprises a housing and a cooling channel extending from a first to a second opening in the housing. The tool comprises a fan arrangement for cooling the battery pack, during use, by forcing air from the first to the second opening in the battery pack housing. The charger comprises a fan arrangement for cooling the battery pack during charging by forcing air from the second to the first opening in the battery pack housing.

This makes it possible to charge the battery pack at high power sooner after use. During use, the discharging of the battery pack makes it develop heat. This heat is cooled off by the fan arrangement in the tool. The cell closest to the air inlet in the battery pack receives the best cooling from the ambient air. Cells further downstream receive to some extent pre-heated air and are cooled less efficiently. The cell closest to the outlet will therefore likely reach the highest temperature. When the battery pack is moved to the charger, the hottest cell will limit the charging. Thanks to the reversing of the air flow in the charger compared to in the tool, the hotter cells now however are cooled more efficiently as they receive ambient rather than pre-heated air. Therefore, the hottest cells more quickly reach a temperature where more efficient charging can take place. Hence, charging at high power can commence more quickly leading to an overall more efficient recharging of the battery pack.

The battery pack may comprise a plurality of battery cells and temperature sensors may be provided both at the battery cell closest to the first opening and the battery cell closest to the second opening. Thereby, the temperature of the hottest battery cell may be determined both during charging and discharging.

The tool may comprise an implement motor and, if so, the fan arrangement may be driven by the implement motor and may in some cases even be attached to the implement motor shaft.

The present disclosure further considers a method for operating a battery-operated system having a tool, a battery pack configured to power the tool, and a charger, for charging the battery pack. The battery pack comprises a housing and a cooling channel extending from a first to a second opening in the housing. The disclosed method includes cooling the battery pack during use thereof by forcing air from the first to the second opening in the battery pack housing. During charging the battery pack is cooled by forcing air from the second to the first opening in the battery pack housing. This provides the above-mentioned advantages regardless of the location of the used fan arrangements.

### BRIEF DESCRIPTION OF THE DRAWINGS

FIG. 1 illustrates schematically and in cross-section a battery pack for a battery-operated system.

FIG. 2A shows the battery pack when used in a battery-operated power cutter.

FIG. 2B shows the battery pack inserted in a charger.

### DETAILED DESCRIPTION

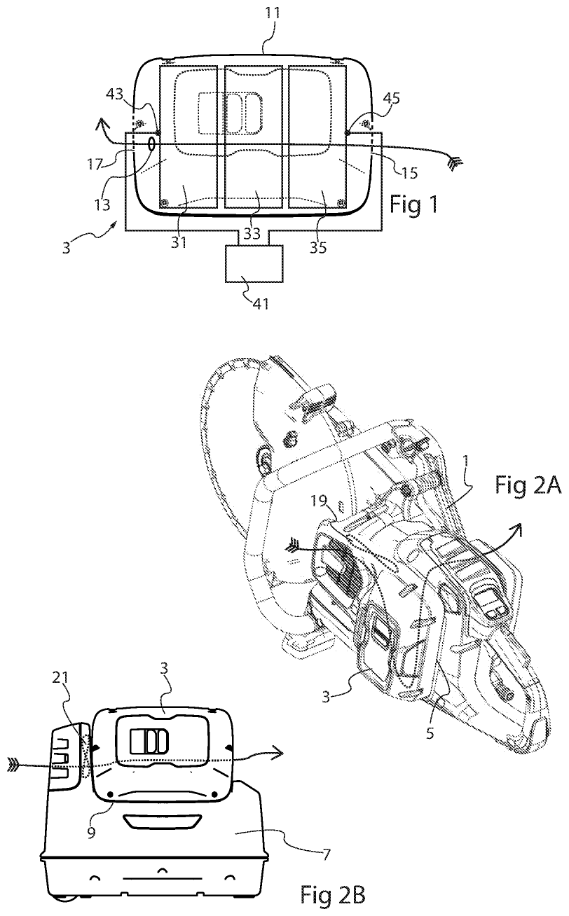

The present disclosure relates generally to battery-operated systems where a battery pack is used intermittently in a tool and is then released from the tool to be recharged in a charger. A system of this kind may use a plurality of such battery packs that may be used to power tools of different kinds, power cutters being only one example. One example of a battery pack for a battery-operated system is illustrated schematically and in cross-section in FIG. 1.

The battery pack 3 comprises a housing 11 that encloses a plurality of battery cells 31, 33, 35 each functioning as an energy storing unit and which can be connected in parallel or in series using charging electronics (not shown) for charging and discharging. During charging and discharging of the battery cells 31, 33, 35 in the battery pack they develop heat, and their temperatures should be limited to improve efficiency and to avoid that electronics in the battery pack and the cells themselves are damaged due to excessive temperatures.

To this end, cooling features are provided in the battery pack 3. The housing 11 is provided with a first 15 and a second 17 opening, and there is formed a cooling channel 13 therebetween such that air can travel from the first opening 15 to the second opening 17 or vice versa thereby passing and cooling the battery cells 31, 33, 35 if they are at a higher temperature than the ambient air. Air can be forced through this cooling channel 13 both during charging and discharging of the battery pack 3. Then, a fan arrangement 21, 19 in the charger 7 and in the tool 1, respectively, may be used to obtain the desired cooling flow passing the battery cells 31, 33, 35.

In the present disclosure, the overall efficiency of the battery-operated system is improved by reversing the direction of the air flow during charging compared to the direction of the air flow during discharging. FIG. 2A shows the battery pack 3 when used in a tool in the form of a battery-operated power cutter 1, inserted in a socket 5 thereof. The tool 1 comprises a fan arrangement 19 for cooling the battery pack 3 during use. The fan arrangement 19 of the power cutter cools the battery pack by forcing air through the cooling channel 13 thereof. Then, air is forced from the first opening 15 to the second opening 17 in the battery pack housing 11, i.e. from the right to the left in the drawing of FIG. 1, or in the direction of the indicated arrow. This means that the battery cell 35 to the right receives the most efficient cooling as it is hit by ambient temperature air (ambient with respect to the battery pack housing 11). The following cells 33, 31 receive increasingly hotter air as the air flow then has been heated by the cell or cells upstream. Therefore, when the power cutter 1 or other tool has been powered for some time the battery cell 31 to the left will be considerably hotter than the battery cell 35 to the right. When the battery pack 3 is moved to be inserted in a socket 9 of a charger 7 and charging is about to commence, a too hot battery cell may limit the possible charging, such that only a reduced charging is allowed or that charging must wait until a suitable battery cell temperature is reached. It should be noted that the battery pack 3 of a power tool may have a capacity of 300 Wh or more and deliver power to tools in the range 2-5 kW. Thus, very high levels of power are handled.

In the present disclosure, the charger 7 also comprises a fan arrangement 21 for cooling the battery pack 3 during charging by forcing air through the cooling channel 13. FIG. 2B shows the battery pack 3 inserted in the socket 9 of a charger 7. The direction of the cooling flow is however reversed, running from the second 17 to the first 15 opening in the battery pack housing 11, i.e. the direction opposite to the arrow of FIG. 1. This means that the hottest battery cell 31 will receive the coolest air at ambient temperature while the subsequent battery cells 33, 35 will receive successively hotter air, heated by the battery cell or cells 31, 33 upstream in the cooling flow. This however need not imply a problem as those battery cells 33, 35 are likely cooled from a lower initial temperature. Thereby, charging of the battery pack 3 can commence sooner and/or can be carried out at a higher charging power.

Returning to FIG. 1, the battery pack may comprise a temperature sensor 43 at the battery cell 31 closest to the second opening in the housing 11 as well as one 45 at the battery cell 35 closest to the first opening 15. Thereby, it is possible both during charging and powering of the tool to determine the highest battery cell temperature using a control unit 41 which may be located in the battery pack and/or in the tool or charger.

The present disclosure is not restricted to the above examples and may be varied and altered in different ways within the scope of the appended claims. For instance, several other tools than circular power cutters can be considered, such as chain saws, leaf blowers, trimmers, etc.

1. A battery operated system comprising a tool, a battery pack configured to power said tool by being inserted in a tool socket of the tool, and a charger comprising a charger socket for charging said battery pack,
wherein the battery pack comprises a housing and a cooling channel extending from a first opening to a second opening in the housing,
wherein the tool comprises a fan arrangement for cooling the battery pack during use by forcing air from the first opening to the second opening in the battery pack housing, and
wherein the charger comprises a fan arrangement for cooling the battery pack during charging by forcing air from the second opening to the first opening in the battery pack housing.

2. The battery operated system according to claim 1, wherein the battery pack comprises a plurality of battery cells and temperature sensors are provided both at a first battery cell that is closest to the first opening and a second battery cell that is closest to the second opening.

3. The battery operated system according to claim 1, wherein the tool comprises an implement motor and the fan arrangement is driven by the implement motor.

4. The battery operated system according to claim 3, wherein the fan arrangement is attached to a shaft of the implement motor.

5. The battery operated system according to claim 1, wherein the tool is a power tool.

6. A method for operating a battery operated system comprising a tool, a battery pack configured to power said tool by being inserted in a tool socket of the tool, and a charger, comprising a charger socket for charging said battery pack, wherein the battery pack comprises a housing and a cooling channel extending from a first opening to a second opening in the housing, the method comprising:
cooling the battery pack during use by forcing air from the first opening to the second opening in the battery pack housing, and
cooling the battery pack during charging by forcing air from the second opening to the first opening in the battery pack housing.
